(19) United States
(12) Patent Application Publication
(10) Pub. No.: US 2006/0055179 A1
(43) Pub. Date: Mar. 16, 2006

(54) Enhanced connection bent wire door striker

(76) Inventor: John E. Burton, Ludington, MI (US)

Correspondence Address: WARNER NORCROSS & JUDD LLP, 900 FIFTH THIRD CENTER, 111 LYON STREET, N.W., GRAND RAPIDS, MI, 49503-2487, US

(21) Appl. No.: 11/077,505

(22) Filed: Mar. 10, 2005

Related U.S. Application Data
(60) Provisional application No. 60/557,175, filed on Mar. 29, 2004.
(60) Provisional application No. 60/598,359, filed on Aug. 2, 2004.

(51) Int. Cl. E05C 3/06

(52) U.S. Cl. 292/216

(57) ABSTRACT

A wire door striker has a wire and a striker plate. At least one leg of the wire may have a ledge near the end. The ledge engages the striker plate when the leg end is fit into an opening in the striker plate. The leg end may have a flat side below the ledge. The flat side fits into the opening in the striker plate and the ledge engages the striker plate. Also, methods of manufacturing a wire with a ledge are disclosed. One method involves flattening an end of the wire to create a flat side and a ledge. Another method involved using a die and a punch.

### PRIORITY CLAIM/CROSS REFERENCE

This application claims the benefit of U.S. Provisional Patent Application No. 60/557,175 filed on Mar. 29, 2004 and U.S. Provisional Patent Application No. 60/598,359 filed on Aug. 2, 2004, which are hereby incorporated in their entireties for all purposes.

### BACKGROUND OF THE INVENTION

This invention relates generally to vehicle door strikers, and in particular, to a vehicle door striker having a bent wire.

Various safety requirements, including those set by governmental agencies and vehicle manufacturers, dictate that striker and door latching systems resist opening in the event of a crash or other mishap so as to protect the occupants of the vehicle from injury. In fact, out of an extraordinary concern for safety, vehicle manufacturers typically set safety requirements more stringent than those which are governmentally imposed.

Automobiles and other vehicles are generally equipped with a latch in the side of each door that engages a striker secured to the vehicle body door pillar at the edge of the door opening. The latch in the door typically includes a slot that opens toward the vehicle interior and extends through a cutout in the face plate of the door. This slot guides the latch over the striker as the vehicle door is closed. As the latch moves over the striker, a pivotally mounted fork bolt that is part of the latching mechanism “strikes” and engages the striker. The striker causes the fork bolt to rotate to a latched position wherein the fork bolt engages the striker to hold the door closed. The fork bolt is held in the latched position until it is released by actuation of a door handle or other mechanism.

Many conventional door strikers have a bent wire that engages the latch in a vehicle door. One common type of door latch striker has a generally U-shaped bolt or wire. Examples of such door strikers 14 are shown in FIG. 1 and disclosed in U.S. Pat. No. 4,323,271 to Taniguchi; U.S. Pat. No. 4,466,645 to Kobayashi; and U.S. Pat. No. 4,981,313 to Makamura. In manufacturing U-shaped bent wire door strikers 14, a wire 15 is bent into a U-shape. The wire 15 is then assembled to the striker plate 17. The wire 15 is secured to the bottom side of the striker plate 17 via peening, riveting, or other attachment means. The wire 15 may be heat-treated and/or equipped with preformed collars 19 before peening. Alternatively, collars 19 may be formed simultaneously on the top and bottom sides of the striker plate 17 during assembly by locally heating and “upsetting” the wire 15. Typically, as shown in FIG. 1, the wire 15 has two substantially equal length legs 20 and 21 joined by a connector section 23. The striker plate 17 has a mounting surface 17a for fastening the striker 14 to a door pillar, a top surface 17c including screw holes 17b, and a wire receiving surface 17d including through holes to receive wire legs 20 and 21. The wire receiving surface 17c is substantially parallel to the mounting surface 17a and is typically raised so that the riveted ends of the wire legs 20 and 21 do not protrude beyond the mounting surface 17a. The connector section 23 is substantially parallel to the striker plate 17. The connector section 23 may be flattened as shown to provide clearance inside the latch of the vehicle door.

Improving the longitudinal and transverse strength of U-shaped bent wire door strikers 14 is very desirable but, due to the nature of existing designs, has not been found feasible without an undesirable increase in the size of the wire 15. As shown in FIGS. 2a and 2b, application of a transverse force T deforms the door striker 14. In striker strength testing, peak strength is not reached until after the wire loop is considerably bent and deformed in the direction of the applied force (transverse or longitudinal) and just prior to the first point of fracture of the wire 15. This deformation is shown in FIG. 2b and 3 and the point at which peak strength is reached is demonstrated in the tests shown in FIGS. 19-21. Referring to prior art FIG. 2b, application of a transverse force T bends both legs 21 and 20. However, leg 21 bears a greater amount of bending and stress from the force than leg 20. As such leg 21 is bent at a large angle G while leg 20 is bent at a much less angle E. The result is that leg 21 fails prematurely at high stress point F. This load imbalance between the legs 20 and 21 becomes clear when the wire 15 is viewed as two rope-like cord lengths X and Y extending away from the area of force application as shown in FIG. 2b. Cord length Y is shorter than cord length X and as a result becomes straight and taught (bearing most of the load) while cord X remains relatively bent and un-taught as the transverse force is applied.

Uneven loading of the legs 20 and 21 also occurs when a longitudinal force L is applied to the wire 15 as shown in FIG. 3. The force is concentrated around leg 21 and can cause failure of leg 21 before leg 20 due to the uneven loading by longitudinal force L.

Another drawback of U-shaped bent wire door striker arises during vehicle collisions. Vehicle collisions can result in the wire 15 becoming trapped behind the latch frame 25 of the latch of a vehicle door. As shown in FIG. 4a, a door pillar 27 of a vehicle may be in close proximity to the latch frame 25. The wire 15 of the striker may be positioned inside the latch frame 25. As shown in FIG. 4b, a collision may impart a force I onto the latch frame 25. The latch frame 25 may be pushed into the striker 14, thereby trapping the wire 15 inside the latch frame 25 and jamming the door shut.

One attempt to address this jamming problem is shown in FIG. 5. FIG. 5 shows a U-shaped bent wire striker 14 having a wire jog outside the latch plate 25 so as not to be trapped in the latch plate 25 during a collision. However, this design adds to the cord length X previously mentioned which creates greater unequal load between legs 20 and 21 and thus an even lower longitudinal and transverse strength.

One attempt to improve strength without increasing the wire diameter involves using a generally L-shaped wire and L-shaped plate. An example of an L-shaped bent wire door striker 29 is shown in FIGS. 6(a)-(c) and disclosed in U.S. Pat. No. 4,998,759 to Peterson et al. The L-shaped design has an improved transverse strength compared to the prior art U-shaped bent wire door striker. However, the L-shaped bent wire door strikers still do not share the longitudinal or transverse force equally between both legs 33 and 35. Transverse force is applied to the L-shaped wire 31 along leg 33. In addition, as shown in FIGS. 6(a)-(c), L-shaped bent wire door strikers are difficult and costly to assemble. The L-shaped wire 31 must be angled into position (FIG. 6(a)) and then peened P in two different directions (FIGS. 6 (b)-(c)). Further, the L-shaped plate adds significantly more material to the striker plate increasing manufacturing cost.

### SUMMARY OF THE INVENTION

The present invention provides a bent wire striker that is cost-effective to manufacture, has a high strength, and overcomes certain of the deficiencies in the prior art.

The present invention provides for a bent wire striker having a wire attached to a striker plate. The wire has two legs connected by a connector section. In one embodiment, the legs are of unequal lengths. In another embodiment, a leg of the wire has at least one jog in it. In yet another embodiment, the wire is attached to the striker plate at two attachment points with one of the attachment points raised with respect to the other attachment point. Alternatively, the attachment points may be at about the same level. In one embodiment, one wire leg has an angled portion which is connected in turn to a shortened connector section.

In one embodiment, a wire striker in accordance with the present invention includes a ledge or plurality of ledges on a wire of a striker. The ledge is provided at the end of the wire or the portion of the wire that engages the striker plate. The ledge, created by a flattened section, provides for increased transverse and longitudinal strength and acts as a shoulder so that the wire is prevented from pushing through the hole in the striker plate. The ledge may be provided in the wire via a number of manufacturing methods.

The terms “striker plate,” “wire,” “attachment point,” “connector section,” “collars,” “cantilevered surface,” “raised portion,” “collar,” “ledge,” “die,” “punch,” and “angled portion” as used herein should not be interpreted as being limited to specific forms, shapes, numbers, or compositions. Rather, the components may have a wide variety of shapes and forms, may be provided in a wide variety of numbers, may be manufactured or configured in a variety of ways, and may be composed of a wide variety of materials depending on the particular needs of an application. In particular, the term “wire” is intended to include any elongated materials and should not be interpreted as being limited to a threadlike material having a circular or rounded cross-section. These and other objects and advantages of the present invention will become apparent from the detailed description, claims, and accompanying drawings.

### DESCRIPTION OF THE DRAWINGS

FIG. 1 is a perspective view of a prior art U-shaped bent wire door striker;

FIG. 2a is a cross-sectional view of the door striker of FIG. 1 shown with a door latch engaged thereto;

FIG. 2b is a cross-sectional view of the door striker of FIG. 2a with a transverse force T applied thereto;

FIG. 3 is a cross-sectional view of the door striker of FIG. 1 shown with a door latch engaged thereto with a longitudinal force L applied thereto;

FIG. 4a is a perspective view of the door striker of FIG. 1 shown engaged to a vehicle door latch prior to a collision;

FIG. 4b is a perspective view of the door striker of FIG. 1 shown engaged to a vehicle door latch after a collision;

FIG. 5 is a perspective view of a prior art U-shaped bent wire door striker shown with a door latch engaged thereto;

FIGS. 6(a)-(c) are a perspective views of a prior art L-shaped bent wire door striker illustrating the steps of assembly;

FIG. 7 is a perspective view of a bent wire striker in accordance with one embodiment of the present invention;

FIG. 8 is a perspective view of a bent wire striker in accordance with one embodiment of the present invention;

FIG. 9a is a cross-sectional view of the bent wire striker of FIG. 8 shown with a door latch engaged thereto;

FIG. 9b is a cross-sectional view of the bent wire striker of FIG. 8, with the configuration of the bent wire door striker after application of a transverse force T;

FIG. 10 is a cross-sectional view of the bent wire striker of FIG. 8 shown engaged to a vehicle door latch;

FIG. 11 is a perspective view of the bent wire striker of FIG. 8 shown engaged to a vehicle door latch;

FIG. 12a is a perspective view of a manufacturing step in accordance with one method of forming a wire of a bent wire striker in accordance with one embodiment of the present invention;

FIG. 12b is a perspective view of a manufacturing step in accordance with one method of forming a wire of a bent wire striker in accordance with one embodiment of the present invention;

FIG. 13 is a perspective view of a manufacturing step in accordance with one method of forming a wire of a bent wire striker in accordance with one embodiment of the present invention with the original position of the wire shown in phantom;

FIG. 14a is a perspective view of a wire of a bent wire striker in accordance with one embodiment of the present invention;

FIG. 14b is a cross-sectional view of the wire of FIG. 14a taken along the plane 14b-14b in FIG. 14a;

FIG. 15a is a perspective view of an assembly step in accordance with one method of assembling a bent wire striker in accordance with one embodiment of the present invention;

FIG. 15b is a perspective view of an assembly step in accordance with one method of assembling a bent wire striker in accordance with one embodiment of the present invention;

FIG. 15c is a perspective view of an assembly step in accordance with one method of assembling a wire of a bent wire striker in accordance with one embodiment of the present invention;

FIG. 16 is a perspective view of a bent wire striker in accordance with one embodiment of the present invention;

FIG. 17a is a perspective view of a bent wire striker in accordance with one embodiment of the present invention;

FIG. 17b is a perspective view of a bent wire striker in accordance with one embodiment of the present invention;

FIG. 17c is a cross section of the bent wire striker of FIG. 17b, taken along the plane 17c-17c in FIG. 17b;

FIGS. 18a-18g are perspective views of a bent wire in accordance with one embodiment of the present invention as varying amounts of transverse force are applied thereto;

FIGS. 19a-19e are perspective views of a prior art U-shaped wire in accordance with a prior art door latch striker as varying amounts of transverse force are applied thereto;

FIGS. 20a-20e are perspective views of a prior art U-shaped wire in accordance with a prior art door latch striker as varying amounts of transverse force are applied thereto;

FIGS. 21a-21d are perspective view of a prior art L-shaped wire in accordance with a prior art door latch striker as varying amounts of transverse force are applied thereto;

FIG. 22 is a perspective view of a bent wire striker in accordance with one embodiment of the present invention;

FIG. 23 is a perspective view of a wire of the bent wire striker of FIG. 22; and,

FIG. 24 is a partial cross-sectional view of the bent wire striker of FIG. 22.

### DETAILED DESCRIPTION OF THE PREFERRED EMBODIMENTS

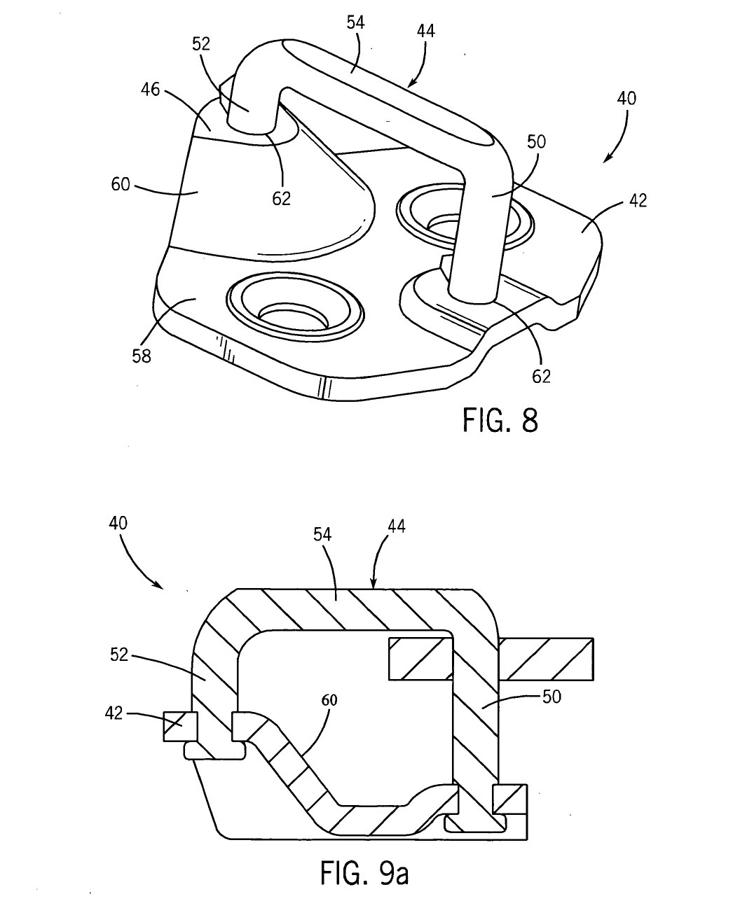

Illustrative embodiments of a bent wire striker (identified generally as 40) in accordance with the present invention are shown in FIGS. 7-18 and 22-24. While the invention may be susceptible to embodiment in different forms, there are shown in the drawings, and herein are described in detail, certain illustrative embodiments with the understanding that the present disclosure is to be considered as an exemplification of the principles of the invention, and is not intended to limit the invention to those embodiments illustrated and described herein. Additionally, features illustrated and described with respect to one embodiment could be used in connection with other embodiments.

The present invention provides for a bent wire striker 40. The striker 40 has a striker plate 42 and a wire 44 attached thereto. The wire 44 may be formed to have two legs 50 and 52 joined by a connector section 54. In one embodiment, attachment point 46 is raised higher than attachment point 48 on striker plate 42 so that legs 50 and 52 are different lengths. For example as shown in FIGS. 7-17, leg 52 is shorter than leg 50.

In the embodiments shown in FIGS. 7-14, legs 50 and 52 are substantially parallel to one another when the wire 44 is attached to the striker plate 42. Preferably, the wire 44 is attached to the striker plate 42 at two attachment points 46 and 48. In embodiments shown in FIGS. 7-11, 14 and 15, the two attachment points 46 and 48 are at different heights compared to the surface 58 of the striker plate 42. For example, attachment point 46 may be substantially higher compared to attachment point 48. In embodiments shown in FIGS. 7-11, attachment point 46 is positioned on top of a cantilevered surface 60. The cantilevered surface 60 is positioned on a raised portion 47 either attached to or formed from the striker plate 42. The raised portion 47 may be any shape and is preferably cone shaped. Attachment point 48 may be incorporated into the surface 58 of the striker plate 42 or may be raised from the surface 58.

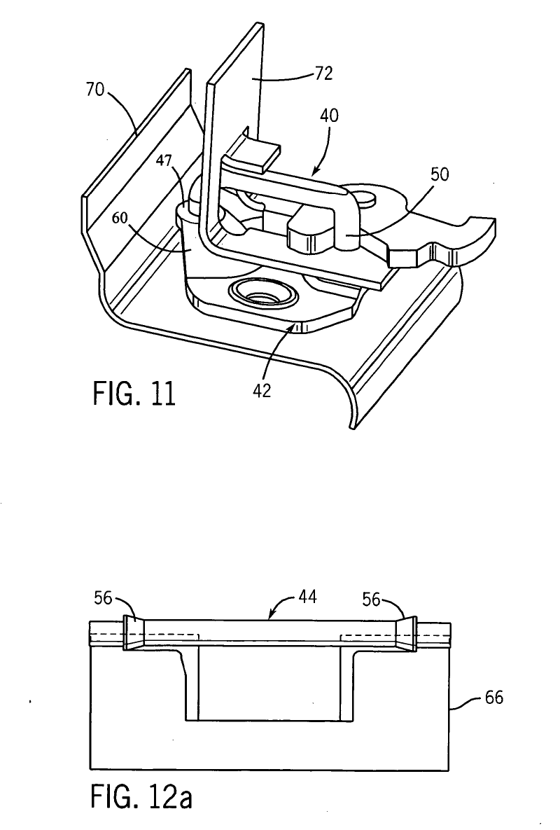

As shown in FIGS. 10 and 11, space in a vehicle door latch mechanism 69 is rather limited. Specifically, the door pillar 70 and the latch frame plate 72 of the vehicle door latch mechanism 69 closely fit together. FIG. 10 shows the cantilevered surface 60 and raised portion 47 of the striker plate 42. The raised portion 47 extends above the radius R of the door pillar 70 of the vehicle door latch mechanism 69. As shown in FIG. 11, this configuration allows leg 52 of the wire 44 to be positioned outside the latch frame 72. As such, the wire 44 will not become trapped in the door latch mechanism 69 during a collision. The bent wire striker 40 is also compact enough to fit within the opening of the latch frame 72 with sufficient clearance.

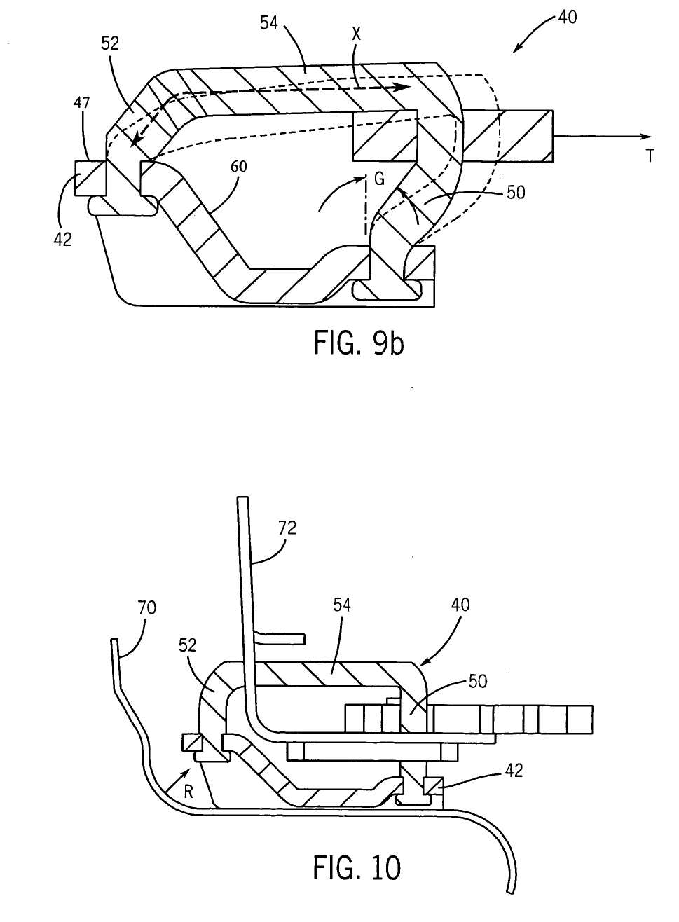

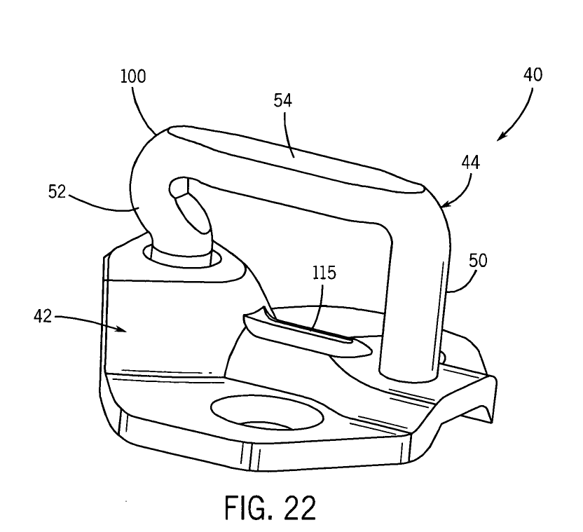

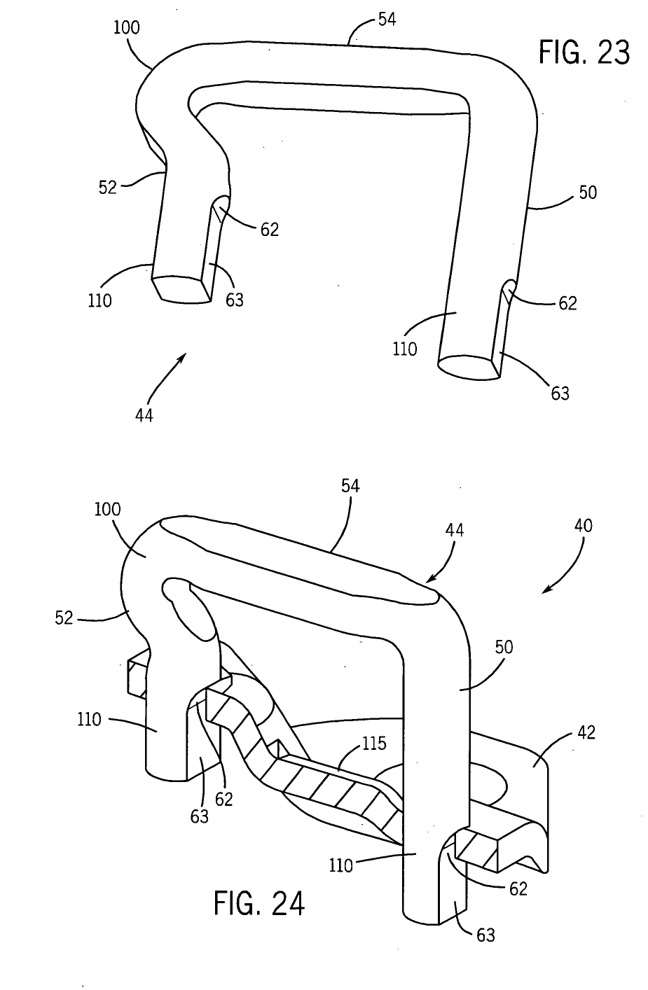

In the embodiment shown in FIGS. 22-24, the wire 44 of the bent wire striker 40 is bent so as to have a jog 100 in leg 52. The jog 100 operates to position a portion of the wire 44 further outside the latch frame 72 when the vehicle door is closed is clearance between the striker and the door pillar is further reduced from what is shown in FIG. 10. This positioning reduces the likelihood that the wire 44 will be trapped in the latch frame 72 during a collision. The present invention may also include a wire jog 100, preferably used in connection with leg 52 to position the wire 44 further outside the latch frame 72, leg 52 having an unequal and shorter length than leg 50. In select embodiments, the jog 100 may have a variable radius. For example, in one embodiment, the jog 100 may have a parabolic radius. In another example shown in FIG. 23, the jog 100 transitions to leg 54 with two distinct radius, R1 and R2 respectively, that form an elliptical arc. Radius R1 is greater than radius R2. This region of the wire bends under transverse or longitudinal strength testing and is an area of high stress. This difference in radius provides for a more gradual transition from the connector section 54 to the leg 52, and reduces the stress concentration in the jog 100. This same type of elliptical arc may also be used as a transition between leg 52 to connector section 54 to achieve the same benefit in any the other embodiments shown, such as but not limited to FIG. 7 and FIG. 9. Other radius configurations could be used depending on the particular application. As shown in FIG. 22 and FIG. 24, the striker plate 42 may also have a raised gusset 115 in between the attachment points 46 and 48 to minimize bending of the striker plate 42 during transverse or longitudinal strength testing as required. Gusset 115 may also be used for the same purpose in any of the other embodiments as well.

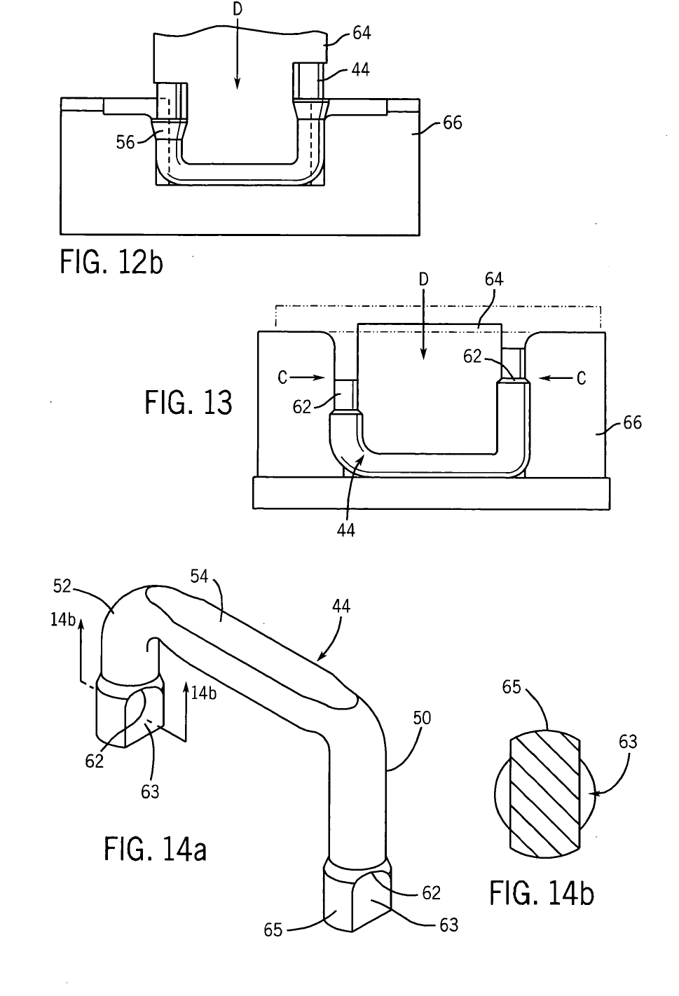

Additional features may be provided on the bent wire striker 40. For example, in embodiments shown in FIGS. 7, 12, 15, and 16, collars 56 may be provided at the attachment points 46 and 48. One possible series of steps for manufacturing a bent wire 44 with collars 56 is shown in FIGS. 12a and 12b. A wire 44 is cold headed so as to form collars 56 thereon. This step utilizes a split die to release the wire 44 after the collars 56 are formed. During the cold heading, pressure from forming the collars 56 distorts the diameter of the wire 44 on either side of the collars 56. Small seams are also created in the wire 44 where the die splits. The cold headed wire 44 is then placed into a bending die 66 as shown in FIG. 12a. As shown in FIG. 12b, a punch 64 travels in direction D, bending the wire 44 into the desired shape. Of course, other methods of manufacturing the wire 44 could be used. For example, if a round wire is not desired or necessary, the wire could be manufactured using a conventional stamping process with steel plate.

Alternatively, as shown in FIGS. 13 and 14, a ledge 62 or ledges 62 may be formed into wire 44. A ledge 62 may be formed into a wire of any wire striker, including prior art strikers, to enhance the strength characteristics. Embodiments of the bent wire striker 40 utilizing a ledge 62 are able to gradually bend with less concentrated stress as opposed to strikers utilizing collars 56. Manufacturing the wire 44 with a ledge 62 is more economical since it eliminates the cold-heading operation needed to preform the collars prior to bending the wire. A wire 44 is placed into a machine with transferring capabilities. This machine flattens the ends of the wire 44 into a ledge 62. The wire 44 is then bent as described above. As shown in FIG. 13, ledges 62 may also be formed while the wire 44 is being bent. In this process, wire 44 is provided onto a die 66. A punch 44 travels in direction D, bending the wire 44. The sides of the die 66 cam inward in direction C to flatten the ends 43 of the wire 44 into a ledge 62 or ledges 62.

As shown in FIGS. 14a and 14b, forming the ledges 62 flattens the wire 44 on a side 63. The displaced material extends from the wire 44 on the other sides 65. The resulting cross-section of the wire 44 with a ledge 62 is about equal to the initial round wire section, thereby maintaining the ultimate strength of the wire 44. Further, maintaining roughly the same cross-section substantially reduces stress concentration at the attachment points 46, 48 between legs 50, 52 and the striker plate 42. While a leg end 110 with ledge 62 may have two flat sides 63 opposite each other, any shape of leg end 110 may be used. For example, the leg end 110 may be square shaped (four flat sides 63), “D” shaped (one flat side 63), or “V” shaped (two angled flat sides 63). In one embodiment shown in FIGS. 23 and 24, each leg 52 and 50 has a ledge 62. The leg end 110 of leg 52 has two flat sides 63 opposite one another and a ledge 62. The leg end 110 of leg 50 has a flat side 63 and a ledge 62. In addition, the ledge 62 may take a variety of shapes and multiple ledges 62 may be provided. As shown in FIG. 23, the preferred shape of the ledge 62 is a radius to minimize stress concentration during longitudinal or transverse strength testing.

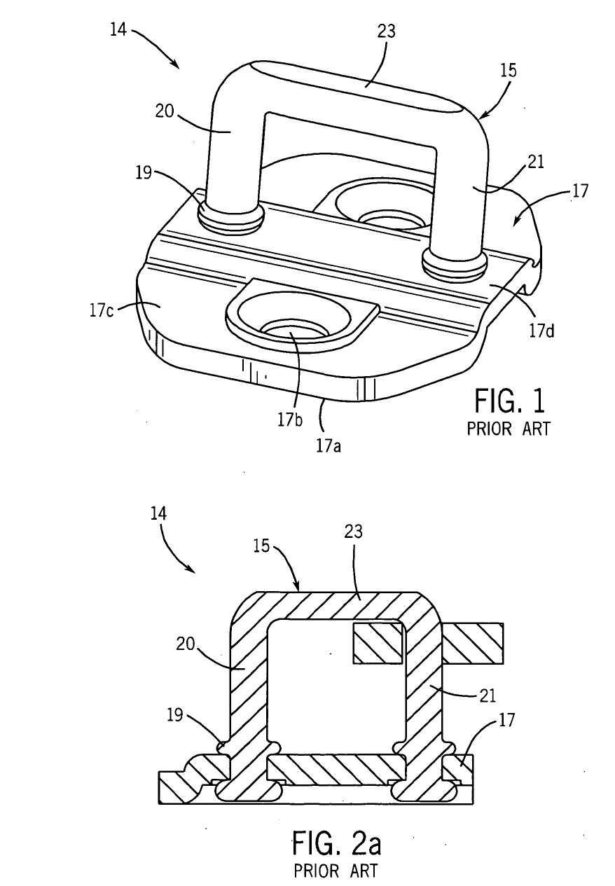

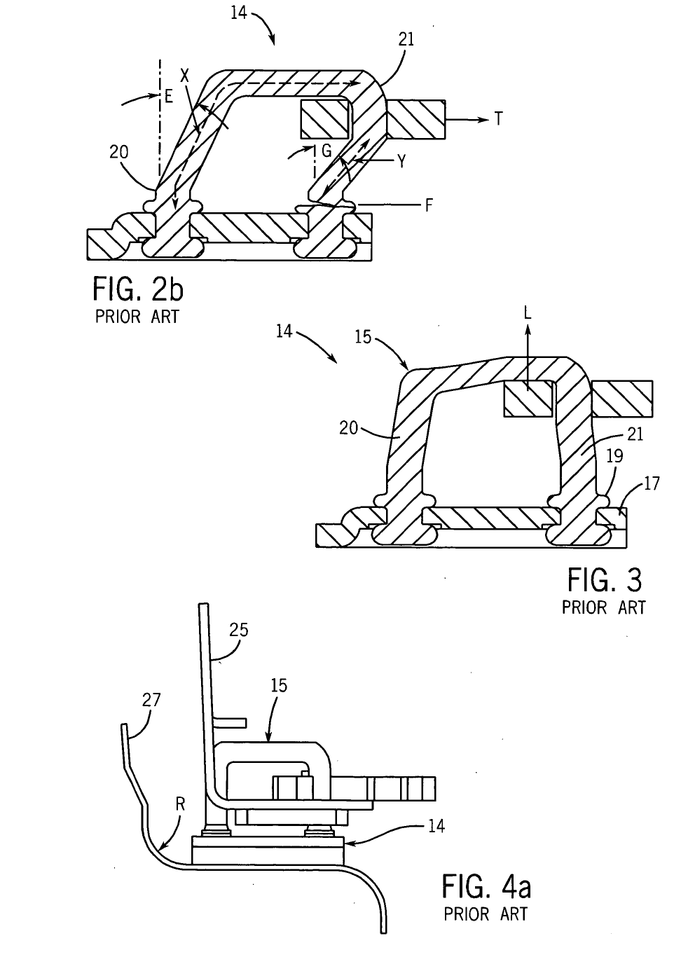

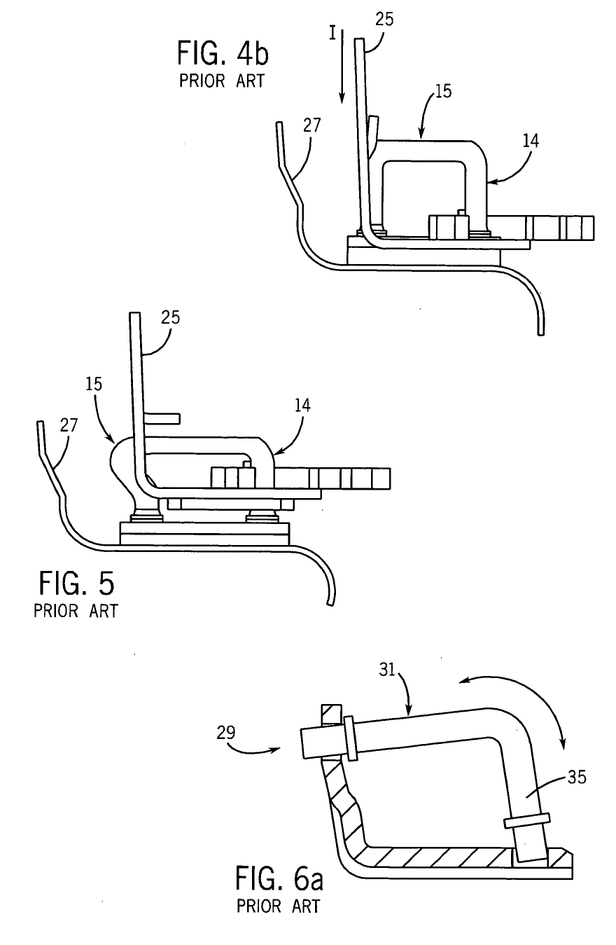

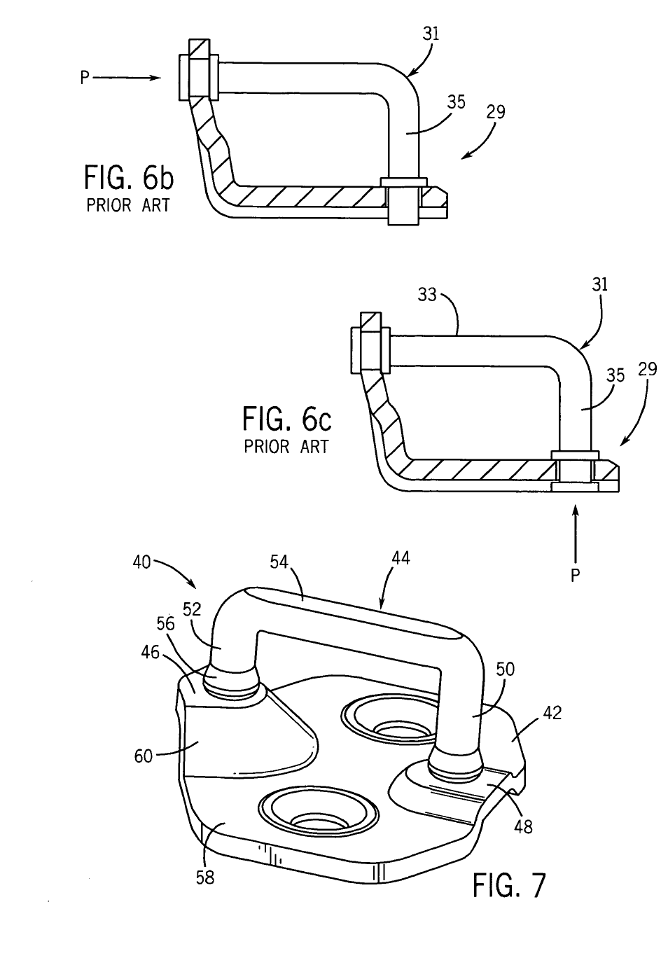

When the striker 44 is tested for strength, a force is applied to the striker 44. As shown in FIGS. 9a and 9b, the wire 44 bends with application of a transverse force T thereto. As shown in FIG. 9b, the chord length X has been reduced compared to the prior art striker shown in FIG. 2b. The bent wire striker 40 with a wire 44 with unequal legs 50 and 52 allows the shorter leg 52 to bend at a steeper angle compared to the legs of prior art strikers and provides greater resistance to the applied transverse force T. The result is that the load of transverse force T is more equally shared between legs 50 and 52. The sum total resistance to the transverse force T by both legs 50 and 52 combines to produce a significantly higher total strength and premature failure of leg 50 is avoided. When optimally proportioned, the chord lengths of the two legs 50 and 51 are such that both legs reach their maximum resistance to the force T at the same time. That is, the chords of the two legs (depending on the design of the wire the chords may include an angled portion 68 or a jog 100) become relatively straight and taught at the same time such that combining the maximum resistance of both legs achieves the highest strength for the assembly.

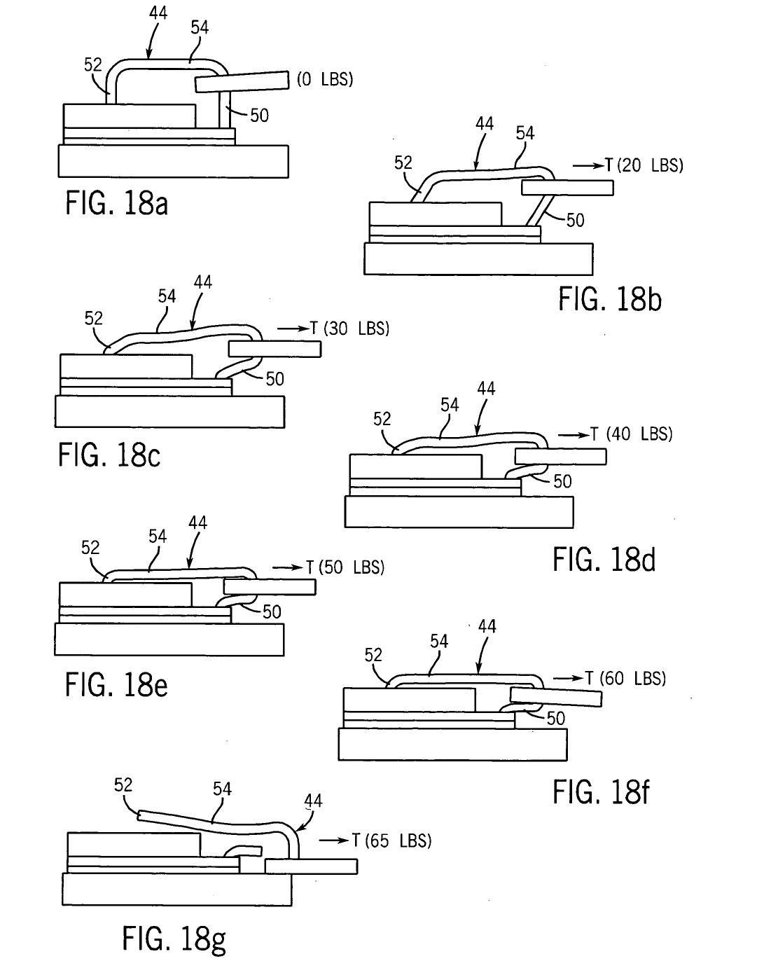

The bent wire striker 40 has a greater transverse strength than prior art U-shaped and L-shaped wire strikers. Tests of the strength of various prior art striker wire forms and the bent wire shape of striker 40 in accordance with the present invention have been conducted to demonstrate the advantages of the invention. The tests were conducted using lead wire with a 0.125 inch diameter, elongation of 17%, and a tensile strength of 3600 psi. The measurements of the wire are indicated on FIGS. 18a, 19a, 20a, and 21a. Transverse force was applied to the strikers by a 6.2 mm thick piece of metal intended to imitate a vehicle door latch. All wires were rigidly held at the attachment points so as to accurately compare the effect of the different configurations. Transverse force was measured with a hand held gauge with a 0-66 lbs scale.

FIGS. 18a-g show a bent wire striker 40 with various amounts of transverse applied thereto. As shown in FIG. 18g, the bent wire 44 in a form in accordance with the present invention failed when 65 lbs of transverse force T was applied thereto.

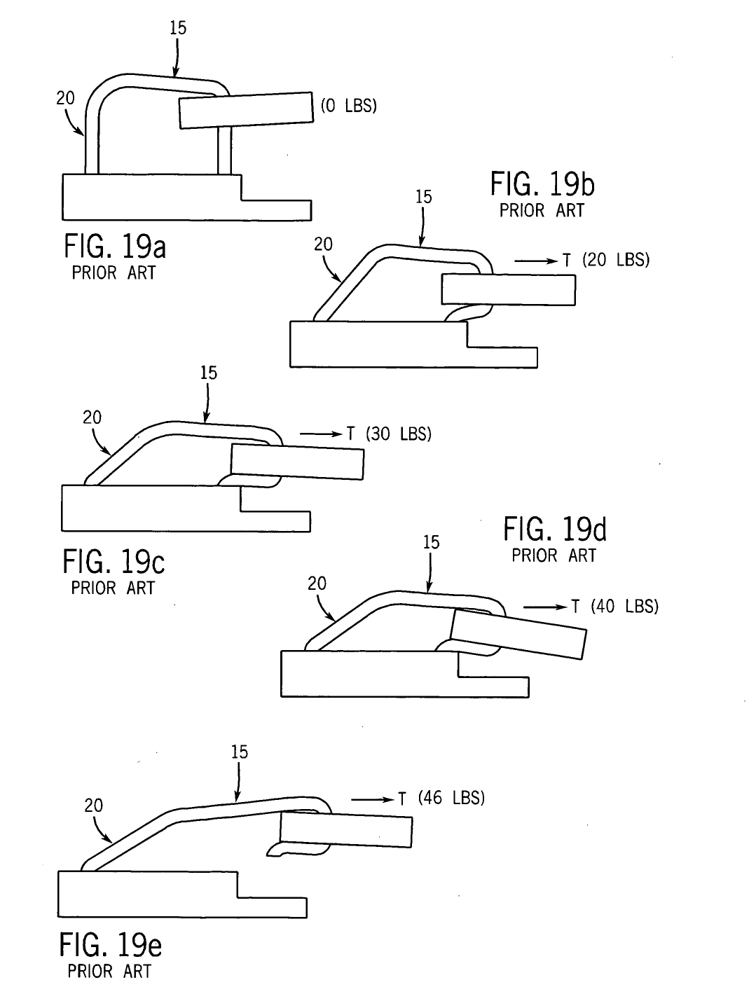

FIGS. 19a-19e show a U-shaped wire in accordance with a prior art door latch striker with various amounts of force applied thereto. As shown in FIG. 19e, the U-shaped wire failed when 46 lbs of transverse force T was applied thereto.

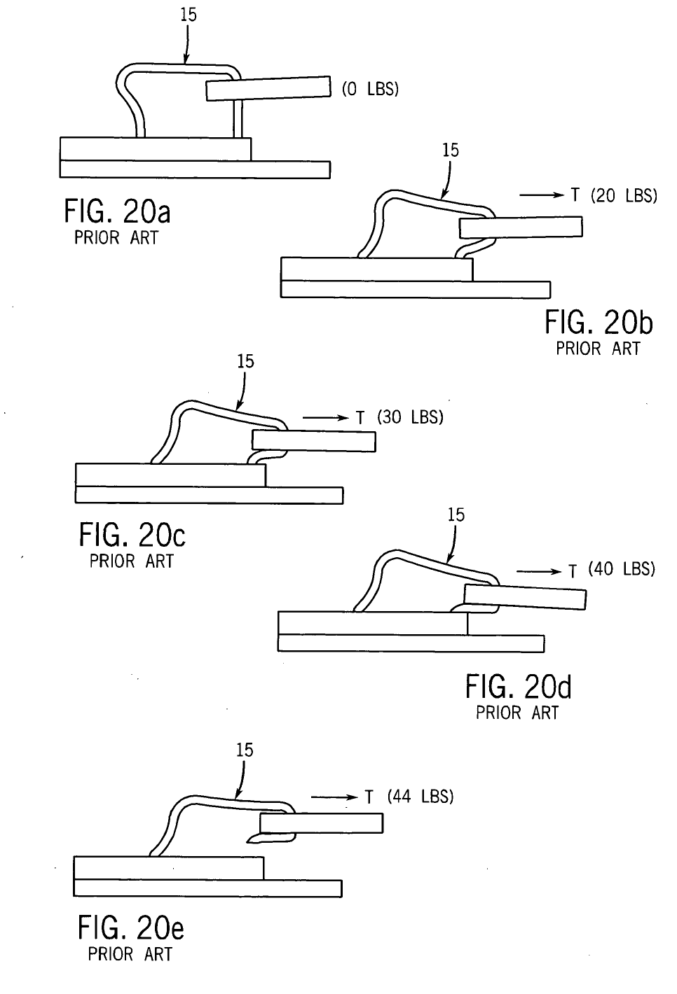

FIGS. 20a-e show a U-shaped wire in accordance with a prior art door latch striker with various amounts of force applied thereto. As shown in FIG. 20e, the U-shaped wire failed when 44 lbs of transverse force T was applied thereto.

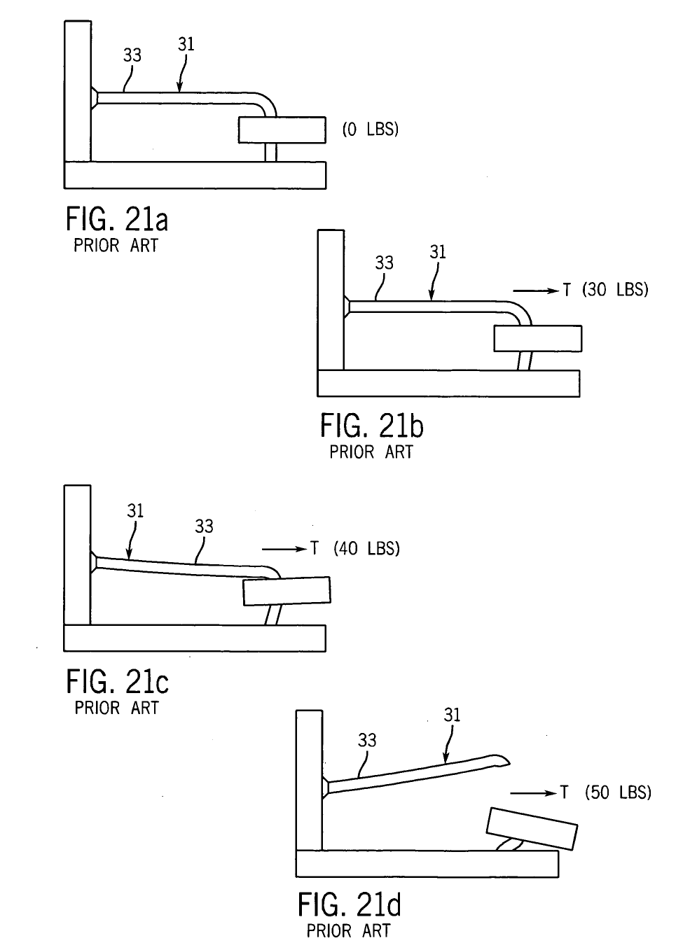

FIGS. 21a-d show a L-shaped wire in accordance with a prior art door latch striker with various amounts of force applied thereto. As shown in FIG. 21e, the L-shaped wire failed when 50 lbs of transverse force T was applied thereto.

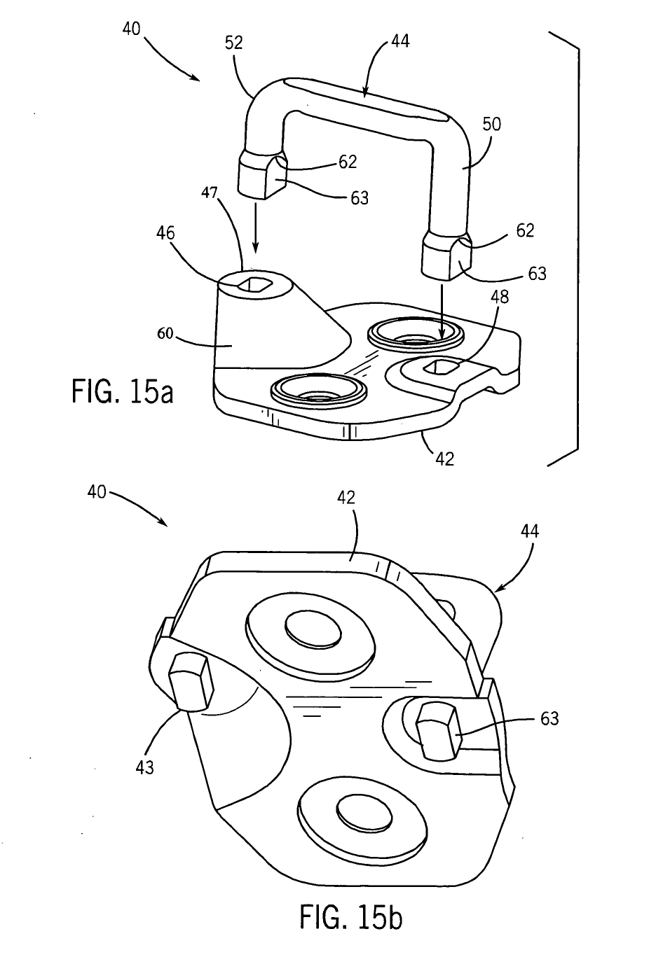

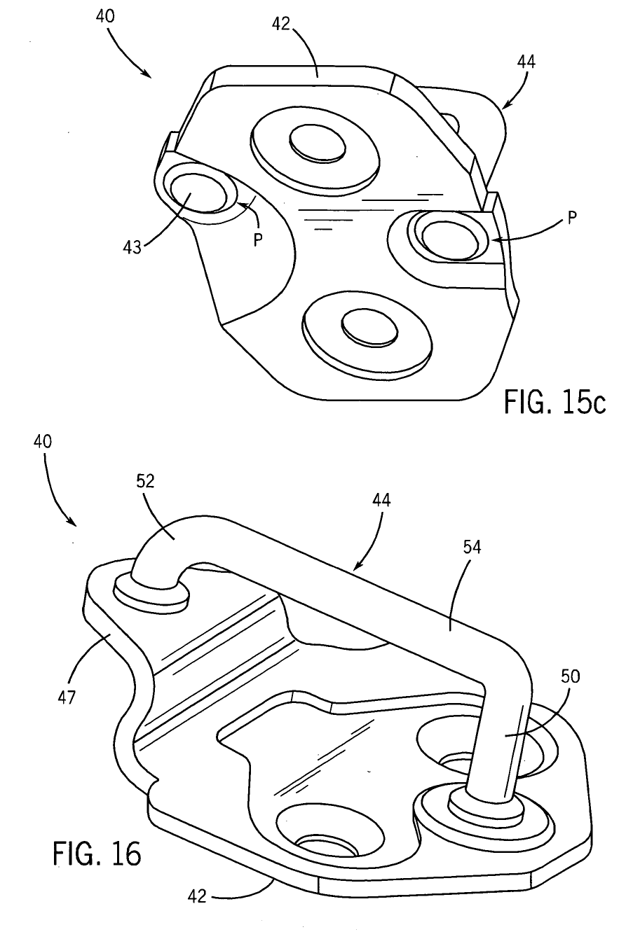

Assembly of the bent wire striker 40 in accordance with embodiments of the present invention is shown in FIGS. 15a-15c. As shown in FIG. 15a, the bent wire 44 is inserted into the striker plate 42. The ends 43 of the wire 44 extend beyond the striker plate 42 as shown in FIG. 15b. As shown in FIG. 15c, the ends 43 are peened or riveted P, thereby securing the wire 44 to the striker plate 42. Of course, the wire 44 may be attached to the striker plate 42 in any number of ways, such as threaded engagement, bolting, or welding. A corrosion resistant coating may be applied to selected components of or the entire bent wire striker 40 either before or after assembly.

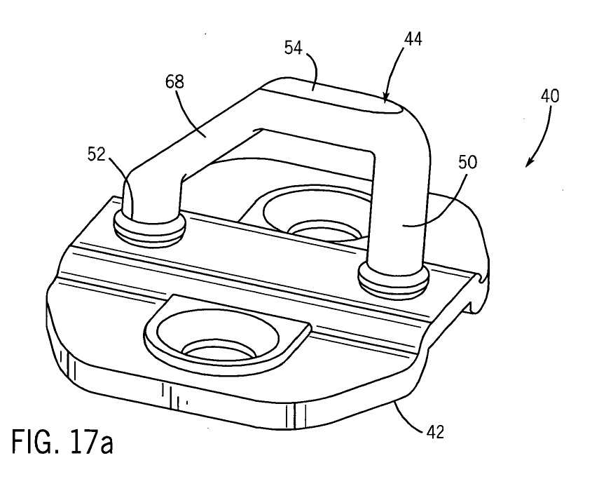

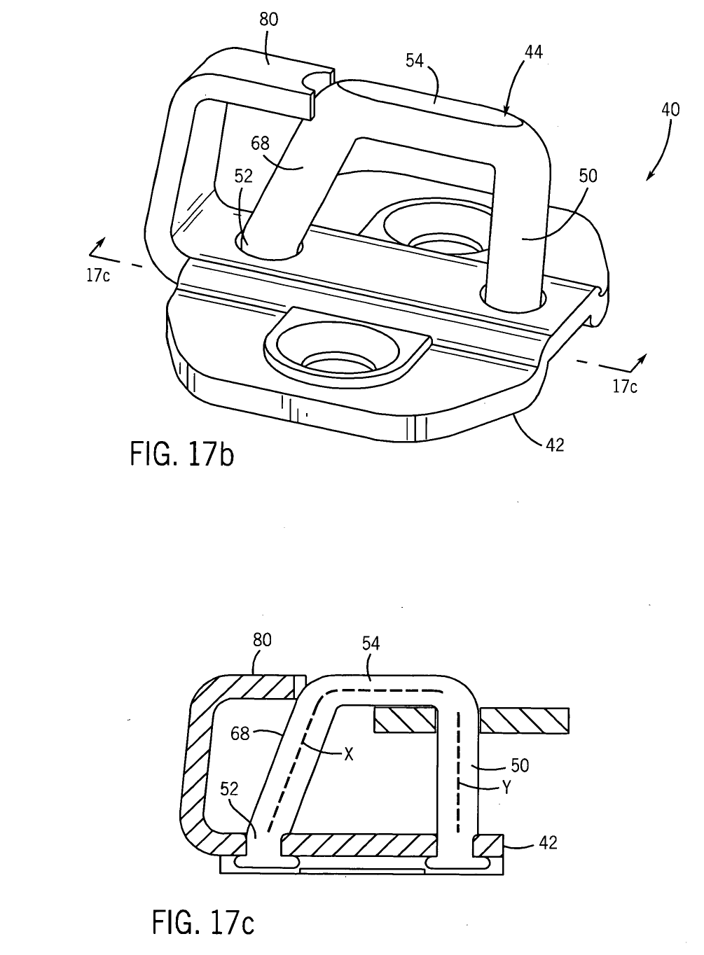

The striker plate 42 may be many shapes or configurations. Examples of preferred embodiments of striker plates 42 are shown in FIGS. 7, 8, 15, 16, and 22. In these embodiments, the striker plate 42 may be any shape or configuration provided that one of the wire-plate attachment points is raised higher than the other so as to shorten the wire chord length X as previously described. The striker plate 42 shown in FIG. 17a or FIG. 17b may be made of any shape or configuration and may or may not have wire-plate attachment points at different heights. The striker plate 42 may be formed of any metal or other material having sufficient strength and performance characteristics. Preferably, the striker plate 42 is formed of high strength low alloy steel such as non-heat treated HSLA 70X. The wire 44 may also be any shape or configuration to achieve a shortened chord length X, but preferably one leg 50 is longer than the other leg 52 as shown in FIGS. 7, 8, 15, and 16. The striker shown in FIGS. 17a, 17b, and 17c uses a wire 44 including an angled portion 68 connecting to the horizontal section 54 shortening its length. In this embodiment, the wire 44 may also be any shape or configuration provided the connector section 54 is shortened to achieve a shortened chord length X as shown in FIG. 17c. Because connector section 54 is shortened, the striker plate shown in FIG. 17b with a U-shaped extension 80 may be used to prevent the striker from being trapped in the latch during a collision. Preferably, the angled portion 68 connects leg 52 to the horizontal section 54 of the wire 44. The length of the angled portion 68, connector section 54, leg 52, and leg 50 and the angle of each relative to the other may vary so that certain or all parts of the wire 44 become taught when peak transverse load is applied to the wire 44. Though not shown, it is also possible and within the scope of this embodiment to have angled portion 68 attach directly to the striker plate 42 at an angle and omit leg 52 entirely. The wire 44 may also be formed of any material, but is preferably formed of heat treated alloy steel such as Society of Automotive Engineers (SAE) grade 4037 or 8620.

The features of the present invention may be used independently or in any combination as desired without departing from the present invention. For example, the bent wire striker 40 may be used in a host of applications not associated with doors. Such applications include without limitation trunk or hood latch strikers. In another example, traditional and prior art strikers, such as the U-shaped and L-shaped strikers, may use ledges as disclosed herein for improved strength in addition to or instead of collars. In yet another example, traditional and prior art strikers may have an attachment point, or multiple attachment points, located on a cantilevered surface or a raised portion. The cantilevered surface and/or raised portion, among other things, prevents the striker from becoming trapped in the latch of a vehicle door after a collision.

The bent wire striker 40 of the present invention may have other applications aside from use in doors and vehicles and the invention may be implemented in a variety of configurations, using certain features or aspects of the several embodiments described herein and others known in the art. Thus, although the invention has been herein shown and described in what is perceived to be the most practical and preferred embodiments, it is to be understood that the invention is not intended to be limited to the specific features and embodiments set forth above. Rather, it is recognized that modifications may be made by one of skill in the art of the invention without departing from the spirit or intent of the invention and, therefore, the invention is to be taken as including all reasonable equivalents to the subject matter disclosed herein and set forth in the claims.

I claim:

1. A door striker comprising:
a wire having at least one leg, the leg having a ledge and an end; and
a striker plate with at least one opening therethrough, the end of the leg positioned through the opening such that the ledge engages the striker plate at the opening.

2. The door striker of claim 1 where the end of the leg has a flat side, the flat side positioned such that it fits at least partially through the opening of the striker plate and the ledge engages the striker plate at the opening.

3. The door striker of claim 1 where the leg has a plurality of ledges.

4. The door striker of claim 2 where the end has a square shape with four flat sides and the leg has four ledges.

5. The door striker of claim 2 where the end has a D-shaped cross-section with one flat side and the leg has one ledge.

6. The door striker of claim 2 where the leg end has a V-shaped cross-section with two angled flat sides.

7. The door striker of claim 1 where the wire has two legs having at least one ledge each.

8. A door striker comprising:
a wire having at least one leg, the leg having a ledge and terminating in an end with a flat side; and
a striker plate with at least one opening, the leg end positioned into the opening such that the end with the flat side passes at least partially through the opening and the ledge engages the striker plate at the opening.

9. A method of manufacturing a door striker comprising the steps of:
providing a bending die with at least one side capable of camming inward;
positioning a wire into the bending die;
using a punch to form the wire to the shape of the bending die;
camming at least one of the sides of the die inward to flatten at least one of the ends of the wire thereby creating a flat side and a ledge; and
securing the wire to a striker plate.

10. The method of claim 9 wherein the step of securing the wire to a striker plate includes the step of inserting the flattened end of the wire into an opening in the striker plate such that the flat end fits at least partially through the opening and the ledge engages the door striker plate at the opening.

11. The method of claim 9 where two sides of the wire are flattened, thereby creating two flat sides and two ledges on at least one end of the wire.

12. The method of claim 9 where four sides of the wire are flattened, thereby creating four flat sides and four ledges on at least one end of the wire.
